(19) United States
(12) Patent Application Publication
(10) Pub. No.: US 2009/0202244 A1
(43) Pub. Date: Aug. 13, 2009

(54) Bidirectional optical transceiver module using a single optical fiber cable

(76) Inventors: Yong Sung Jin, Seoul (KR); Man Jin Sohn, Calgary (CA); Yung Sung Son, Calgary (CA)

Correspondence Address: JACOBSON HOLMAN PLLC, 400 SEVENTH STREET N.W., SUITE 600, WASHINGTON, DC, 20004, US

(21) Appl. No.: 11/630,778

(22) PCT Filed: May 28, 2005
(86) PCT No.: PCT/KR05/01590

§ 371 Date: Dec. 26, 2006

(30) Foreign Application Priority Data
Jun. 24, 2004 (KR) 10-2004-0047869

(51) Int. Cl. H04J 14/00

(52) U.S. Cl. 398/67

(57) ABSTRACT

Present invention is related to optical transceiver module using optical fiber cable and the detail is related to optical transceiver module transforming bi-directional transmission by single fiber cable using two different wavelength lights. Optical module is formed by modularized light emitting device, light receiving device, filter and lens and their optical alignment is accomplished by connecting them. In order to make accurate alignment, transmitter module with light emitting device included and receiver module with light receiving device included are connected to lens module by guide hole and guide pin molded by machined precisely. Lens module includes lens shape part to make light focusing effectively.

### TECHNICAL FIELD

Present invention is related to optical transceiver module using optical fiber cable and the detail is related to optical transceiver module transforming bi-directional transmission by single fiber cable using two different wavelength lights.

In optical communication, electrical to optical conversion means converting the electrical signal to optical signal by ON and OFF of light emitting device from digital electric signal input and optical to electric conversion means converting optical signal to electric signal by light receiving device receiving the optical signal from the transmitted signal through optical cable. Massive data can be transmitted to long distance by means of optical communication.

### BACKGROUND ART

Optical cables for transmitting the data and receiving the data are necessary to send and receive the data simultaneously from two different locations. Because optical cable itself has not directivity, light can be transmitted from A to B location in a cable and light can be transmitted from B to A location conversely. That means optical data can be transmitted both direction with an optical cable. But optical signal from light emitting device and optical signal to light receiving device should be splitted and so a module is required to separate transmitting optical signal and receiving optical signal as shown in FIG. 1.

FIG. 1 shows a schematic diagram for conventional bidirectional optical transceiver module. To separate receiving and transmitting signal effectively, two different wavelength (l1, l2) light are used at each point. For example, if light emitting device (104) with l1 wavelength is used at A point, then light emitting device (104b) with l2 wavelength is used at B point. Generally light emitting diode (LED) or laser diode (LD) is used as an light emitting device (104, 104b) and photodiode (PD) is used as a light receiving device (105, 105b). As shown in FIG. 1, optical filter (101) transmits and optical filter (102) reflects l1 wavelength light emitted from light emitting device (104) and so l1 wavelength light enters into optical cable (107) and cannot goes to receiving device (105). The same priciple applies to B point and this enables bidirectional optical transmission with one optical cable (107).

Conventional bidirectional optical transceiver module as described above has problems to use expensive metal based TO can package and to require precise optical alignment for lens, optical filters (101, 102) and optical cable (107) for the assembly. To make optical alignment, light emitting device in TO can package (104) needs operating to emit light and devices and optical components inside of optical transceiver module requires precise optical alignment process to deliver the light to receiving device (105) inside of optical transceiver module at opposite side. After achieving optical alignment, TO can packages with light emitting device (104) and light receiving device (105) are welded to metal based body (103). Optical alignment process as described above is called active alignment. Active alignment needs considerable time for assembly and requires very expensive equipment like laser welding machine with alignment capability. To overcome those problems described above, passive alignment process without active process is devised. Passive alignment process uses prealigned structure to align optical devices instead of optical alignment process. Usually optical waveguide as optical device or silicon optical bench based on semiconductor process are used or combination of optical waveguide and silicon optical bench is possible.

Specifically, optical waveguide is a device propagating the light in a confined space structure using similar operating priciple. Light propagates through core surrounded lower refractive index material. Optical waveguide can be fabricated within 1 mm accuracy because it uses semiconductor fabrication processw. Once light is incident to optical waveguide, light is confined and guided mainly core inside and so light can be transmitted to specific position without optical alignment. Optical alignment can be achieved by arranging optical fiber, optical filter, light receiving device and light emitting device. Optical waveguide itself can be fabricated precisely but prealigned structure is needed to arrange optical waveguide, light receiving device and light emitting device at a specific position. Precisely prealigned structure can be implementeb by silicon optical bench. Fabrication process to fabricate silicon optical bench is explained below.

Specifically patterned thin film is deposited on the silicon substrate using photolithography process. Specific patterned groove is formed by soaking silicon substrate in etching solution and blocking the etching solution with thin film patterned selectively. The fabricated structure is called silicon optical bench and fine alignment can be achieved by inserting optical waveguide, light receiving device and light emitting device onto the fabricated groove of silicon optical bench. As shown optical aligned components using semiconductor process has very high precise accuracy but the fabrication process is not easy and suitable for low cost volume manufacturing. Those precise components need another structure to be assembled and so required accuracy cannot be maintained unless all the parts are fabricated by semiconductor process. But fabrication of all devices using semiconductor process is not possible in reality and so solution for the problem is required.

### DISCLOSURE OF INVENTION

### Technical Problem

The objective of the present invention is to provide bidirectional optical transceiver module using a single optical fiber cable formed by modularized light emitting device, light receiving device, filter and lens and their optical alignment is accomplished by connecting them individually and so the present invention enables low cost volume production. Another objective of the present invention is to provide bidirectional optical transceiver module using a single optical fiber cable using plastic injection which enables low cost volume production. Another objective of the present invention is to provide transmitting module and receiving module which enables electric shielding.

### Technical Solution

To achieve ojective of the present invention, the present invention includes transmitting modudule including light emitting device; receiving module including light receiving device; filter module separating transmitting and receiving light; and lens module connecting transmitting module, receiving module, filter module and optical fiber cable, and accomplishes optical alignment by connecting them individually.

Most desirable proces to fabricate transmitting module, receiving module, lens module and filter module is plastic injection forming individually. Lens module includes receptacle connecting optical fiber cable; first connecting part connecting lens module and transmitting module at a specific position; second connecting part connecting lens module and receiving module at a specific position; and third connecting part connecting lens module and filter module at a specific position.

### Advantageous Effects

According to the present invention, transmitter module with light emitting device mountded and receiver module with light receiving device mounted are connected to lens module by guide hole and guide pin molded by machined precisely and light emitting device, light receiving device and optical fiber cable are aligned precisely by simply connecting each modules. And lens formed inside of lens module enables focusing the light into optical fiber cable effectively. Moreover, all the parts including lens module are manufactured by plastic injection forming process and this enables low cost volume production.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

### BRIEF DESCRIPTION OF THE DRAWINGS

FIG. 1 shows a schematic diagram for conventional bidirectional optical transceiver module.

FIG. 2 is schematic diagram showing bidirectional optical transceiver module using a single optical fiber cable by present invention.

FIG. 3 shows performing bidirectional optical transmission using the present invention.

FIG. 4 shows lens module and filter module structure of FIG. 2.

FIG. 5 shows magnified picture of filter module in FIG. 4.

FIG. 6 illustrates light beam trajectory from light emitting device to optical fiber cable.

FIG. 7 illustrates light beam trajectory from optical fiber cable to light receiving device.

FIG. 8 shows structure of transmitter module in FIG. 2.

FIG. 9 shows structure of receiver module in FIG. 2.

FIG. 10 illustrates structure of receiver module shielded in FIG. 9.

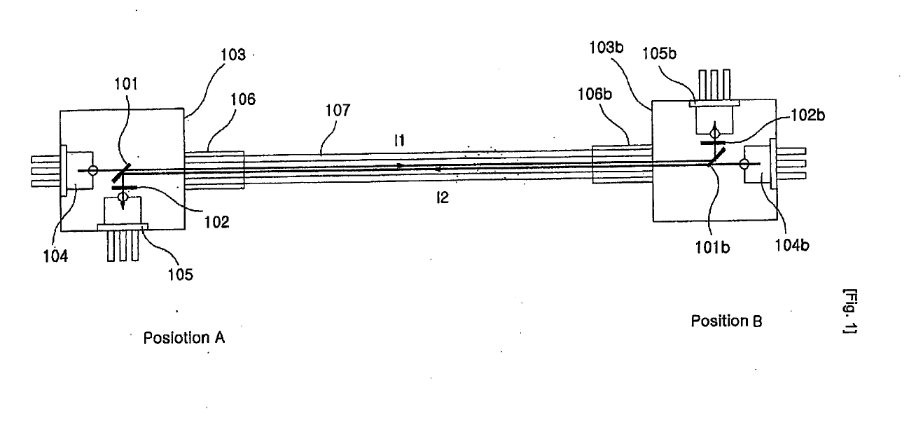

### MODE FOR THE INVENTION

Optical transceiver module takes digital electric signal as an input, converts it to optical signal using light emitting device, transmits to optical transceiver module at opposite site and conversely receives optical signal from optical transceiver module at opposite site and converts it to electric signal. Each optical wavelength for transmitting and receiving shall be different because transmission and reception of optical signal use a single optical fiber cable.

Present invention accomplishes optical alignment by connecting transmitter module (223) and receiver module (224) including light emitting device (204) and light receiving device (205) respectively to lens module (221) fabricated by plastic injection molding.

Transmitter module (223) includes light emitting device (204) and light emitting diode (LED) or vertical cavity surface emitting laser (VCSEL) is used as light emitting device generally. Transmitter module (223) takes digital electric signal as an input, converts it to optical signal using light emitting device and transmits to optical transceiver module at opposite site.

Receiver module (224) includes light receiving device (205), which converts light to electric signal, and photodiode is used as light receiving device generally. Receiver module (224) receives optical signal transmitted from optical transceiver module at opposite site using light receiving device and converts it to electric signal.

Lens module (221) and filter module (222) separates transmitted and received optical signals. So bidirectional optical transmission is possible with a single optical fiber cable. Lens module (221) includes transmitter lens (211) collimating the light from transmitter module (223), receiver lens (212) focusing the light to light receiving device (205) inside of receiver module (224) and receptacle lens (213) focusing the light to optical fiber cable and collimates the light from optical fiber cable simultaneously. To separate optical signals transmitted and received effectively, the wavelengths for transmitting and receiving shall be different and optical filter (201) inside of filter module (222) is used. Filter module (222) separates optical signals between transmitted and received. Optical filter (202) is located in front of receiver module (224) which blocks the light from the transmitter module (223).

Separation of two optical signals can be implemented by using two optical filters (201, 202). One optical filter (202) reflects long wave light and transmits short wave light, the other optical filter (201) transmits long wave light and reflects short wave light conversely. One transmitter module (223) at A location uses light emitting device (204) emits long wave light and the other transmitter module at B location uses light emitting device (204b) emits short wave light. Long and short wavelength denotes relative value respectively and does not mean absolute value. The difference between long and short wavelength can be varied in a certain range and any difference which can be separated by optical filters. For example, 850 nm VCSEL and 780 nm VCSEL can be used as light emitting device respectively. Optical filter at 45 degree is inserted between optical fiber cable (207) and transmitter module.

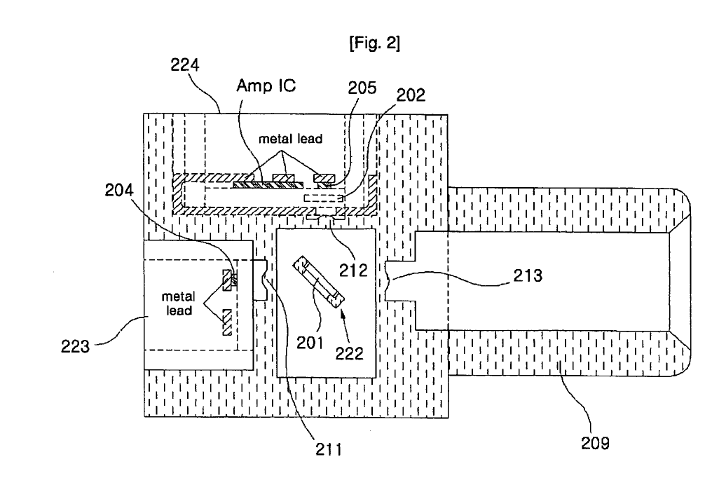

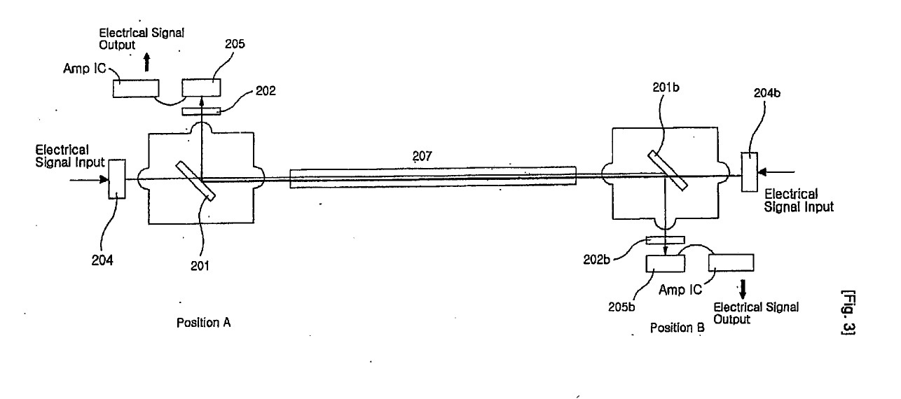

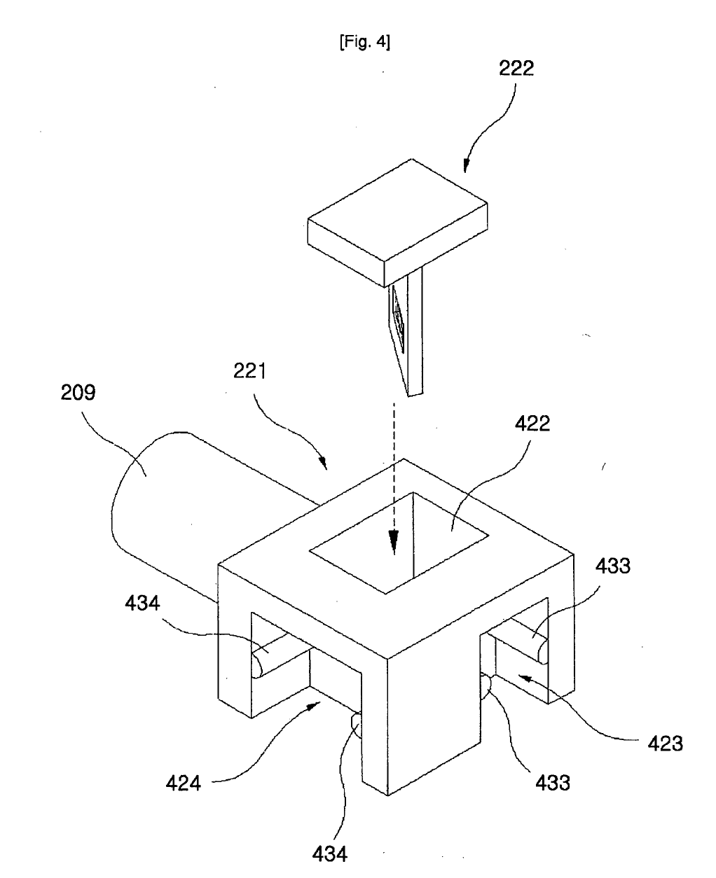

FIG. 4 shows lens module and filter module structure of FIG. 2. Guide pins (433, 434) are formed at module inserting part to align transmitter module (223) and receiver module (224) precisely. Lens module (221) is fabricated by plastic injection molding. Said lens (211, 212, 213), inserting part (422, 423, 424) and guide pin (433, 434) are formed as fully integrated piece by injection molding. The material of lens module (221) shall be transparent because light can be transmitted through lens module. Transparent poly methylmetacrylate (PMMA) or polycarbonate (PC) can be used as material.

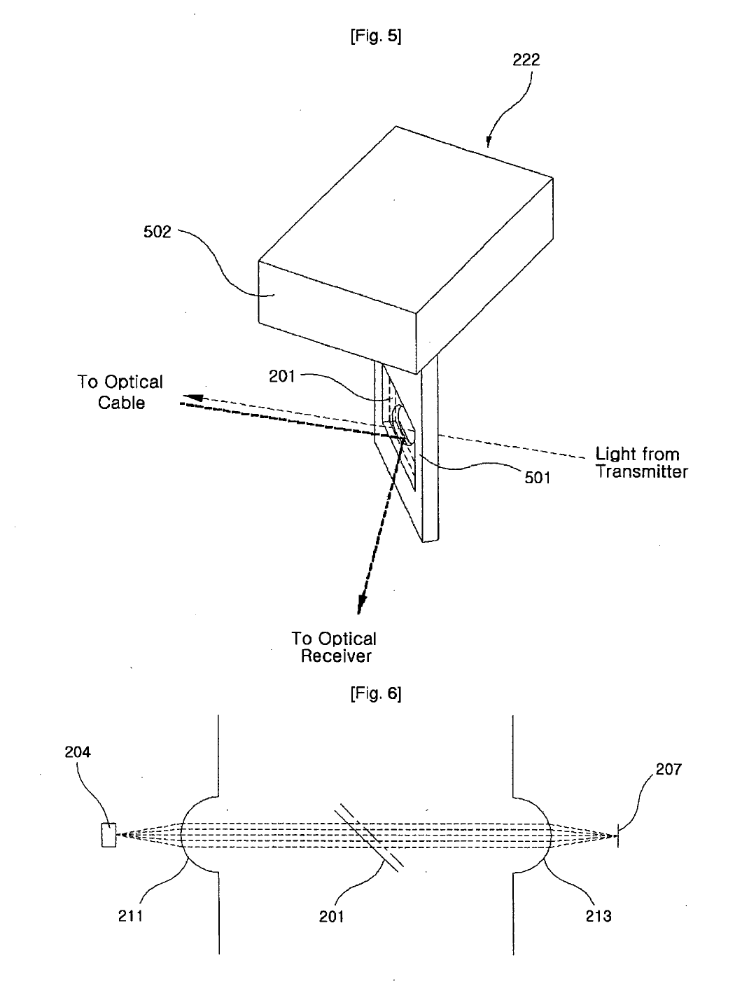

FIG. 5 shows magnified picture of filter module in FIG. 4. Filter module (222) is fabricated as a separate part to insert optical filter (201) to lens module (221) easily. Optical filter has dimension of 1 mm×1 mm with 0.1˜0.2 mm thick. Handling and insertion of optical filter (201) is very difficult due to small and thin size. To insert and align optical filter properly, filter module (222) including optical filter (201) inserted is used. Filter module (222) has base (501) for inserting optical filter (201). Base has through hole to transmit light. Filter module is easy to handle and insert to lens module owing to bigger size than optical filter. Top portion of filter module can be used as a cover to protect inside of lens module from foreign material like dust. Filter module is fabricated by conventional plastic inejction molding.

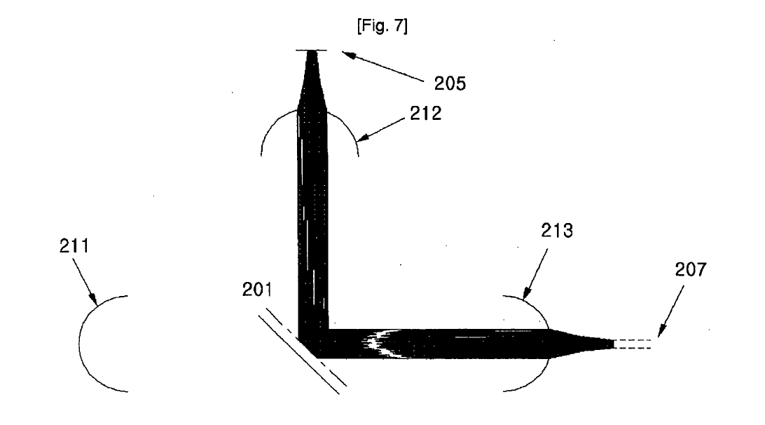

FIG. 6 illustrates light beam trajectory from light emitting device to optical fiber cable.

FIG. 7 illustrates light beam trajectory from optical fiber cable to light receiving device.

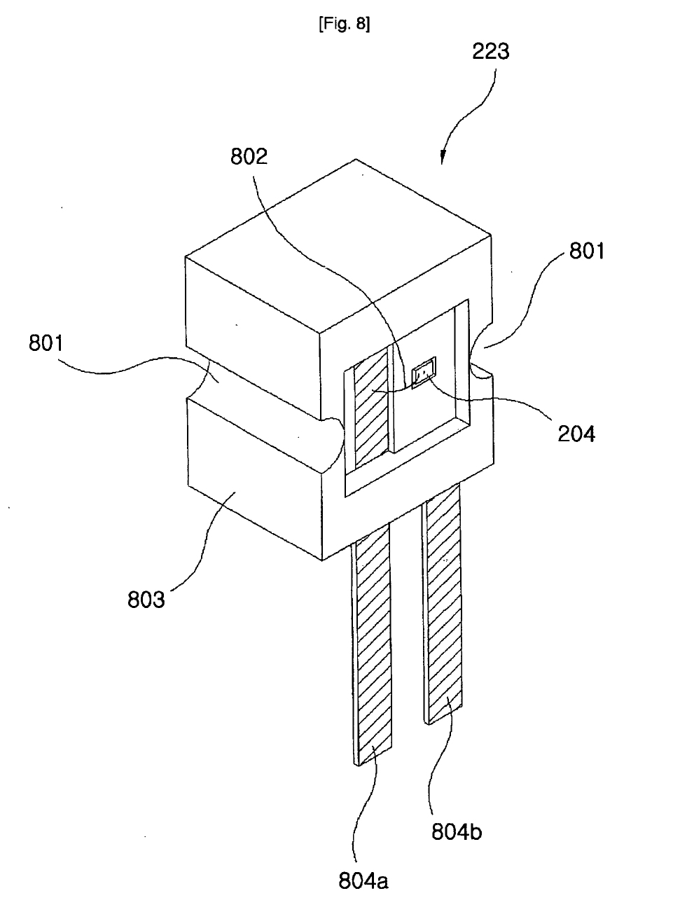

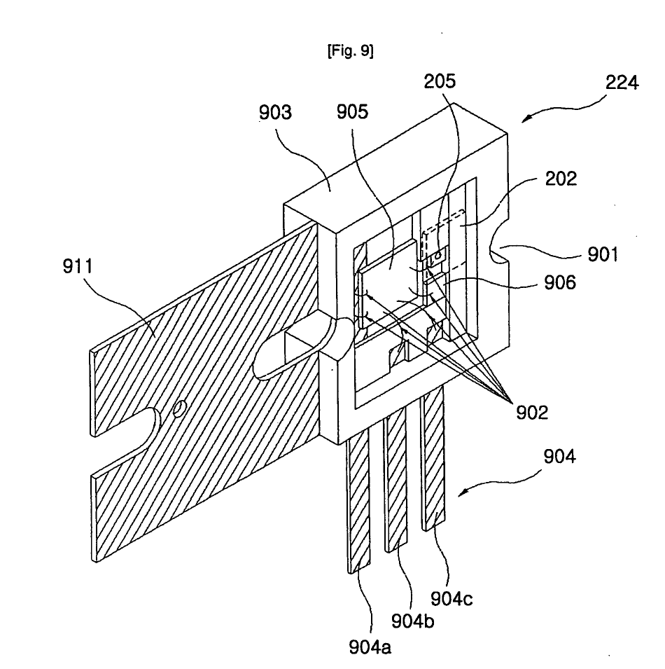

FIG. 8 shows structure of transmitter module in FIG. 2.

Transmitter module (223) includes metal lead frames (804a, 804b) transferring electric signal to light emitting device, a pre-groove is formed to insert light emitting device at a specific position onto the lead frame, and light emitting device is inserted into the groove. Guiding groove (801) is formed at both sides of transmitter module (223) to connect with guiding pin (433 in FIG. 4) at lens module (221). Center of transmitter side of lens module and center of light emitting point of light emitting device will coincide as the guiding pin of lens module connects to guiding groove of transmitter module. Transmitter module is fabricated by plastic injection molding.

Metal lead frame (804b) is exposed at the bottom side of groove inserting light emitting device (204) of transmitter module (223) and light emitting device is mounted over the surface after dispensing small amount of electrically conducting adhesive on the exposed surface of metal lead frame inside groove and then lead frame (804b) and bottom side of light emitting device is connected electrically. Top side metal pad of light emitting device and another lead frame (804a) is connected by using thin metal wire (802). By doing so, electric current signal can be transferred through lead frames (804a, 804b).

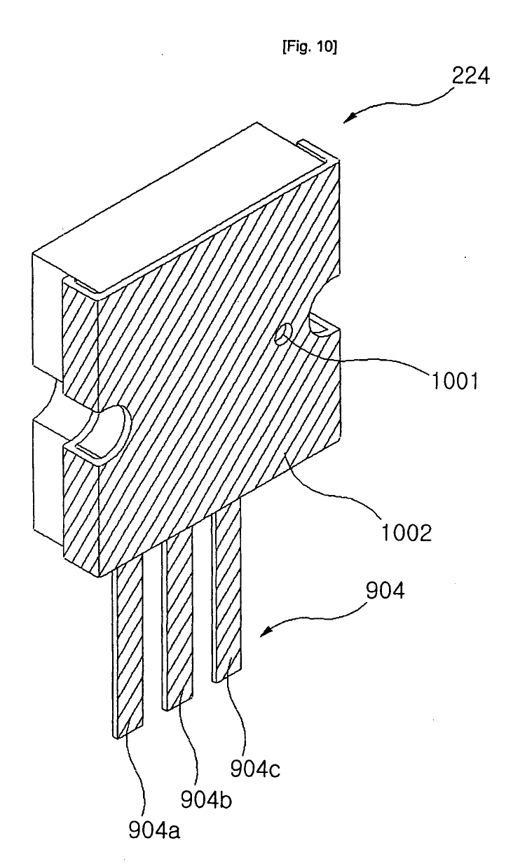

FIG. 9 shows structure of receiver module in FIG. 2.

Receiver module (224) includes metal lead frames (904a, 904b, 904c) transferring electric signal generated from light receiving device (205), and a pre-groove is formed to insert light receiving device at a specific position onto the lead frame. The groove is pre-aligned to make center of light receiving aperture and center of lens coincide when receiver module (224) connects to lens module (221). In addition to receiving device (205), preamplifier IC (905) for amplifying electric signal generated from light receiving device (205) and other component to drive preamplifier like capacitor (906) are inserted. Guiding groove (901) is formed at both sides of receiver module (224) to connect with guiding pin (434) at lens module (221). Receiver module is fabricated by plastic injection molding. Metal lead frame (904c) is exposed at the bottom side of groove inserting light receiving device (205) of receiver module (224) and light receiving device is mounted over the surface after dispensing small amount of electrically conducting adhesive on the exposed surface of metal lead frame inside groove and then lead frame (904c) and bottom side of light receiving device is connected electrically. Bottom side of light receiving device connected through lead frame (904c) is connected to preamplifier (905) by using thin metal wire (902). Top side metal pad of light receiving device (205) is connected to preamplifier (905) directly by using thin metal wire (902). Preamplifier is mounted by dispensing electrically conducting adhesive over the surface of other metal lead frame (904a). Extended metal lead frame (911) connected to bottom surface of preamplifier denotes metal cover for electric shielding and 903 denotes body of receiver module formed by plastic injection molding. Optical filter (202) is mounted over the light receiving device (205) and fixed by using glue like epoxy bond. Optical filter (202) blocks stray light except light from transmitter module at opposite site.

FIG. 10 illustrates structure of receiver module shielded in FIG. 9.

Receiver module is covered with extended metal lead frame connected to grounding by folding the extended metal lead frame as shown in FIG. 10. This makes receiver module shielded electrically inside. 1001 denotes through hole to transmit light to light receiving device. Electrical shielding as described above can prevent electromagnetic wave radiation outside due to high frequency signal emitted from preamplifier and also protect photodiode output signal from electromagnetic wave coupled from outside. Additionally blocking stray light from outside can enhance optical signal sensitivity.

### INDUSTRIAL APPLICABILITY

Present invention shall be used for high speed digital data transmission widely such as datacom networks, access networks, home networks, storage area networks and consumer fiber optics for digital multimedia transmission such as IEEE 1394, DVI/HDMI, USB and so on.

Present invention reduces manufacturing cost and process dramatically compared to conventional optical transceiver module for optical communication. So present invention enables widespread deployment of optical transmission products in industry and consumer market.

1. A bi-directional optical transceiver module using a single optical fiber cable comprising: an optical transmitting module including light emitting device; an optical receiving module including light receiving device; a filter module separating the lights transmitted and received by directing the transmitting light from said optical transmitting module towards optical cable and by directing the receiving light from said optical cable; and a bi-directional optical transceiver module using a single optical fiber cable including lens module aligning bidirectional optical transceiver module optically by combining said optical transmitting module, optical receiving module, filter module and said optical cable.

2. The bi-directional optical transceiver module using a single optical fiber cable as claimed in claim 1, wherein said optical transmitting module, optical receiving module, lens module and filter module are fabricated by plastic injection molding individually.

3. The bi-directional optical transceiver module using a single optical fiber cable as claimed in claim 1, wherein said lens module includes receptable connecting with said optical fiber cable; first connecting part connecting said lens module and optical transmitting module each other at a prealigned position; second connecting part connecting said lens module and optical receiving module each other at a prealigned position; and third connecting part connecting said lens module and filter module each other at a prealigned position.

4. The bi-directional optical transceiver module using a single optical fiber cable as claimed in claim 3, wherein said lens module includes optical transmitting lens collimating the light emitting from the said light emitting device; optical receiving lens focusing the light from the said optical fiber cable and making incidence to said receiving device; and receptable lens focusing the light from the said emitting device and making incidence to said optical fiber cable and collimating the light emitting from the said optical fiber cable towards optical transceiver module side.

5. The bi-directional optical transceiver module using a single optical fiber cable as claimed in claim 1, wherein said filter module comprising: transmitting the first wavelength light and reflecting the second wavelength light different from the first wavelength.

6. The bi-directional optical transceiver module using a single optical fiber cable as claimed in claim 3, wherein said first connecting part includes guide pin formed at either said lens module or transmitting module; and guide hole formed at either said lens module or transmitting module.

7. The bi-directional optical transceiver module using a single optical fiber cable as claimed in claim 3, wherein said second connecting part includes guide pin formed at either said lens module or transmitting module; and guide hole formed at either said lens module or transmitting module.

8. The bidirectional optical transceiver module using a single optical fiber cable as claimed in claim 3, wherein said third connecting part includes groove on the said lens module to combine said filter module to lens module; and top side of said filter module is inserted and fixed to said groove on lens module.

9. The bi-directional optical transceiver module using a single optical fiber cable as claimed in claim 3, wherein said transmitting module includes a groove located at the corresponding position to the center of transmitter lens when said lens module and transmitter module are connected by said first connecting part; and said light emitting device is inserted to the groove and the emitting light from the emitting device is incident to the center of the transmitter lens.

10. The bi-directional optical transceiver module using a single optical fiber cable as claimed in claim 3, wherein said receiving module includes a groove located at the corresponding position to the center of receiver lens when said lens module and receiver module are connected by said second connecting part; and said light receiving device is inserted to the groove and the light from the receiving lens is incident to the center of the light receiving device.

11. The bidirectional optical transceiver module using a single optical fiber cable as claimed in claim 4, wherein said transmitter lens, receiver lens, receptacle lens and receptacle in the lens module are formed as one body by transparent material.

12. The bi-directional optical transceiver module using a single optical fiber cable as claimed in claim 3, wherein said receiver module includes a lead frame part for electric shielding and embodies electric shielding by folding the part for shielding and covering top surface of said receiver module after inserting said light receiving device and electrical device.

13. The bi-directional optical transceiver module using a single optical fiber cable as claimed in claim 3, wherein said transmitter module includes a lead frame part for electric shielding and embodies electric shielding by folding the part for shielding and covering top surface of said transmitter module after inserting said light emitting device.
